(19) United States
(12) Patent Application Publication
(10) Pub. No.: US 2021/0366014 A1
(43) Pub. Date: Nov. 25, 2021

(54) METHOD OF GENERATING AND ACCESSING PRODUCT-RELATED INFORMATION

(71) Applicant: Netorus, Inc., Princeton, NJ (US)

(72) Inventors: Fei Wang, Shanghai (CN); Deliang Zhu, Shanghai (CN); Yue Gan, Plainsboro, NJ (US)

(73) Assignee: Netorus, Inc., Princeton, NJ (US)

(21) Appl. No.: 16/637,373

(22) PCT Filed: Aug. 8, 2018
(86) PCT No.: PCT/US2018/045797

§ 371 Date: Feb. 7, 2020

Related U.S. Application Data
(60) Provisional application No. 62/542,513, filed on Aug. 8, 2017.

(51) Int. Cl. G06Q 30/06; G06K 7/14

(52) U.S. Cl. CPC G06Q 30/0623; G06K 7/1417

(57) ABSTRACT

The present invention implements methods for generating and accessing product-related multi -language electronic documents in the quality control system and disseminating and tracking the electronic documents by two-dimensional barcodes that are generated by the variable data printing technology. The present invention simplifies the disseminating process for the electronic documents and provides multi-language support for different countries and regions.

### CROSS-REFERENCE TO RELATED APPLICATION

This application claims priority under 35 U.S.C. § 119(e) to U.S. Provisional Patent Application Ser. No. 62/542,513, filed on Aug. 8, 2017, the disclosure of which is incorporated herein by reference in its entirety.

### FIELD OF THE INVENTION

The present invention generally relates to a method of generating and accessing product-related information and more specifically relates to a method of generating and accessing product-related information associated with a two-dimensional (2D) barcode.

### BACKGROUND OF THE INVENTION

A 2D barcode is a graphical image that stores information both horizontally and vertically. As a result of this construction, 2D codes can store up to 7,089 characters, a significantly greater storage than what is possible with the 20-character capacity of a unidimensional barcode. A Quick Response (QR) code is the most popular variant of the different types of 2D barcodes. The QR code system, developed in 1994, was originally used in the auto industry for tracking vehicles during manufacturing. It allows high-speed component scanning. As a new information storage, transmission, and identification technology, the QR code system has a broad range of applications, including commercial tracking applications and convenience-oriented applications aimed at mobile-phone users. It has been extensively used in government agencies, warehousing and logistics industry, and many other industries.

In industries such as pharmaceutical, chemical, nutraceutical and food, government agencies, manufacturers, suppliers, distributors, or wholesalers need to check and verify various documents of a product in order to track the quality of the product. The documents includes batch production records, batch inspection records, analysis certificates, KOSHER certification, nutrition tables, etc. At present, most of these documents are manually recorded and entered into local databases, or partially generated by a Laboratory Information Management System (LIMS) software. Manual input and integration may involve human error.

This is especially true for batch and inspection records. The current system is inefficient because vendors, manufacturers, distributors, and wholesalers need to keep their own records. Tracking the history of a specific product is time-consuming and may lead to false information due to human error.

There is, therefore, a need in the pharmaceutical, chemical, food and many other industries, for a method to efficiently and conveniently generate and/or retrieve product-related information, such as inspection records and test records, to minimize human error, and to ensure the correctness of an inspection process,

### SUMMARY OF THE INVENTION

The present invention addresses this need by providing an e-serialization method of generating and accessing product-related information. The method of generating and accessing product-related information comprises generating an electronic document related to a product and associating the product-related electronic document to a two-dimensional (2D) barcode. The 2D barcode can be decoded to access the electronic document. The 2D barcode can be a Quick Response (QR) code. The method of the present invention may include selecting a test method specific to a product type and an inspection standard associated with the product. The method may continue with conducting a product inspection process according to the selected test method and inspection standard.

The electronic document generated by the present method may be a multi-language document and may include a batch production record, a batch inspection record, or an analysis certificate of the product. The electronic document may be stored in a database.

The present method may include validating integrity of the QR code. The QR code may comprise a digital signature and a link associated with the electronic document stored in the database. The digital signature can be used to authenticate a user and to determine an appropriate level of product information the user is authorized to access. The link can be a Universal Resource Locator (URL) address for accessing the electronic document on a Web server.

The method of the present invention may further include scanning the QR code by a scanning device and extracting from the QR code the link related to the electronic document in the database, and retrieving the electronic document from the database. The method may continue with displaying a content of the retrieved electronic document on the scanning device.

The scanning device can be a mobile device, such as a mobile phone and a tablet. The electronic document retrieved by the present method may be in a predetermined language. The predetermined language can be a default language set in the scanning device.

### BRIEF DESCRIPTION OF THE DRAWINGS

FIG. 1 is a block diagram of an exemplary method of the present invention for automatically generating and storing a multi-language electronic files by the quality control system.

FIG. 2 illustrates a method of the present invention for printing a Quick Response (QR) code using a variable printing technique.

FIG. 3 illustrates a method of the present invention for associating a multi-language electronic document with a QR code printed on an outer packaging (e.g., primary packaging, secondary packaging).

FIG. 4 illustrates a method of the present invention for tracking and disseminating a multi-language electronic document using the QR code technology.

FIG. 5 illustrates a method of the present invention for obtaining an electronic documents by scanning a QR code label printed on an outer packaging(e.g., primary packaging, secondary packaging).

FIG. 6 illustrates an ideal network model supporting the quality control system of the present invention. The network model includes a Web server and a data server.

### DETAILED DESCRIPTION OF THE INVENTION

To aid in the understanding of the invention, the following non-limiting definitions are provided:

The singular forms “a,” “an,” and “the” include plural referents unless the context clearly dictates otherwise.

The term “(s)” following a noun contemplates the singular or plural form, or both.

The term “and/or” means any one of the items, any combination of the items, or all of the items with which this term is associated.

The phrases “in one embodiment,” “in various embodiments,” “in some embodiments,” and the like are used repeatedly. Such phrases do not necessarily refer to the same embodiment, but they may unless the context dictates otherwise.

The terms “comprising,” “having,” and “including” are synonymous, unless the context dictates otherwise.

The terms “2-D barcode”, “2D barcode”, and “matrix barcode” are synonymous and generally refer to a two-dimensional barcode with encoded information that a scanner may read both horizontally and vertically.

The object of the present invention is to provide a method of generating and accessing multi-language electronic document that comprises product-related information. The object of the present invention can be achieved by employing an intelligent translation method to automatically generate and store the multi-language electronic document on a cloud server for products in different quality, production, sale, and usage. A QR code label may be generated by a variable data printing technique. The multi-language electronic document may be identified via an artificial intelligent method based on a Uniform Resource Locator (URL) embedded in the QR code for the electronic document and a product identification code. The method of the present invention allows end users to access, query, record, store, and disseminate the multi-language electronic document. It also enables end users to track and trace manufacturing processes, testing records, quality assurance status, and information regarding transportation, distribution, sales, and usage based on the user privilege, and verify the validity of the electric document. It provides end users with a convenient solution to identify the genuineness of the product and detect counterfeit goods by using a mobile device. Moreover, the present method provides an effective quality control and safety risk monitoring system for health-related industries, such as pharmaceuticals, health products, food, cosmetics, and chemicals.

The present invention provides the ability for network compatible devices to access electronic documents on the cloud server by scanning and decoding QR codes with various user privilege settings. The present invention also provides the ability to consolidate the systems between printing plants and product manufacturers via the cloud server with a variable data printing technology enabled. A unique QR code label for each product may be generated and printed, so that product manufacturers are able to control and bookkeep the printed QR code label. The present invention further provides the ability for displaying a multi-language version of the electric document according to user preferences.

The method of the present invention comprises generating an electronic document related to a product and associating the product-related electronic document to a two-dimensional (2D) barcode. The 2D barcode can be decoded and used to access the electronic document. The method of the present invention may include selecting a test method specific to a product type and an inspection standard associated with the product. The method may continue with conducting a product inspection process according to the selected test method and inspection standard. Different polices, rules, and regulations may be implemented in different countries and regions for the same product. It is of importance to customize inspection standards and testing methods based on product types (e.g., raw and auxiliary materials, packaging materials, intermediates, finished products) to comply with different regulations. The present invention provides an effective way which permits an authorized user to login to the cloud server and customize inspection standards and testing methods for a specific product type to ensure compliance. The inspection and test procedures may be executed in accordance with the customized inspection standards and test methods. The electronic document encompassing these inspection standards and test methods and results thereof may be generated and stored in a database hosted in the cloud server.

In some embodiments, the electronic document generated by the present method may be a multi-language document. The generation of the multi-language document can be performed automatically, using a free or commercially available computer-assisted translation tool, such as MateCat, MemoQ, MEMOrg, OmegaT, OpenTMS, SmartCAT, Skype Translator, Wordfast, and XTM-CAT. The computer-assisted translation tool can be Web-based or installed on a local computer for offline use. Languages into which the electronic document is translated, including without limitation, Arabic, Bengali, Chinese, English, French, German, Hindi, Korean, Indonesian, Italian, Javanese, Japanese, Lahnda, Portuguese, Russian, Spanish, Tamil, Turkish, and Vietnamese. Ability of the present method to generate product-related multi-language electronic documents and the disseminating process provide the multi-language support for different countries and regions.

The electronic document may include various product-related information, such as the information required by Good Manufacturing Practices (GMP). It may include quality manuals, policies, standard operating procedures (SOPs), batch production records, test methods, specifications, logbooks, batch inspection records, various certificates, and information about suppliers, distributors, and customers. SOPs may provide step-by-step instructions for performing operational tasks or activities. Batch production records may include step-by-step instructions for production-related tasks and activities, besides including areas on the batch production record itself for documenting such tasks. Test methods may include step-by-step instructions for testing supplies, materials, products, and other production-related tasks and activities. Test methods may also contain forms for documenting the testing and the results of the testing. Specifications may include requirements that a supply, material, or product must meet before being released for use or sale.

The electronic document may be stored in a database. In some embodiments, the database may be a transitional database which may have all database-related files hosted on the same host for it to operate as intended. In some embodiments, the database may be a distributed database, in which storage devices are not all attached to a common processor. It may be stored in multiple computers, located in the same physical location; or may be dispersed over a network of interconnected computers. Unlike parallel systems, in which the processors are tightly coupled and constitute a single database system, a distributed database system consists of loosely coupled sites that share no physical components. In some embodiments, the database is a cloud database that may run on a cloud computing platform (e.g., Amazon Web Services,

Google Cloud SQL, EnterpriseDB, Microsoft Azure, MongoLab). Access to the cloud database is generally provided as a service. One of the advantages of cloud database services is scalability and high availability of the database.

The 2D barcode used to associate the electronic document related to the product can be any one of 2D barcodes standards, including, but not limited to QR Codes, Data Matrix codes,

Aztec codes, MaxiCode, Semacode tags, Cauzin Softstrip codes, EZcode, High Capacity Color Barcode (HCCB), CyberCode, Mobile Multi-Coloured Composite (MMCC), Dot codes, PDF417 symbols, ShotCode, SPARQCode, WaterCode, Trusted Paper Key (TPK), and the like. Some 2D barcodes may contain information in an encrypted form. Moreover, many 2D barcodes have been optimized for use with smartphones and other mobile phones such that they may be read quickly and accurately with or without an auto-focus camera. The QR code are extensively used in marketing campaigns to connect consumers from print and outdoor media to digital content (both offline and online). It has the capability to redirect users to a website, video, social media profile, coupon, App Store, and map location. The QR code can also store offline information such as text, phone number, email address, contact info in vCard format, and a pre-loaded SMS. In various embodiments, the QR code is used to associate with and access the electronic document on the cloud server.

QR codes may be generate by a QR code generator. Numerous QR code generators are available for choice, including without limitation, Kaywa, GOQR.me, Visualead, and QR Stuff. In some embodiments, QR code labels may be generated using a variable data printing (VDP) technique. VDP is a form of digital printing, including on-demand printing, in which elements such as text, graphics and images may be changed from one printed piece to the next, without stopping or slowing down the printing process and using information from a database or external file. VDP allows information specific to each electronic document to be encoded in each QR code generated. There are many software packages available to merge text and images into VDP print files, including AccuZIP, Adobe, dBase, and Xerox. QR codes may be generated in any one of image file formats, including but not limited to, ANI, BMP, CAL, EPS, FAX, GIF, IMG, JBG, JPE, JPG, JPEG, MAC, PBM, PCD, PCX, PCT, PGM, PNG, PPM, PDS, RAS, SVG, TGA, TIFF, and WMF. QR codes in an image file format may be printed directly or transferred to a third party (e.g., packing company, product manufacturer) for printing. Compared with the conventional QR code printing method, VDP does not require QR code printers and/or test equipment to be equipped on production lines. The QR code labels may be affixed to the primary packaging and/or secondary packaging of the product. Primary packaging is the first-level product packaging such as the bottle, can, jar, tube, etc., that contains the item sold. Secondary packaging is the layer of packaging that surrounds groups of pre-packaged parts that are enclosed in the primary packaging.

QR codes can embed web addresses, phone numbers and other contact information. They create shortcuts to make it easier to engage mobile device users. QR codes can provide a seamless connection from static print to the web. In some embodiments, the QR code may embed a link associated with the electronic document. The link can be a URL address which can be used to access the electronic document on a Web server. In some embodiments, the QR code may include a digital signature and a link associated with the electronic document stored in the database. The digital signature may be used to authenticate a user and to determine an appropriate level of product information the user is authorized to access. For example, a general user may view product instruction manuals of the product and an authorized user may view the batch records, inspection records, and certificates. Non-limiting examples of encryption methods, which may be utilized to generate the QR code containing the digital signature, include Advanced Encryption Standard (AES) and Data Encryption Standard (DES). Thus, the encrypted QR code provides an additional layer of security. Individuals may be able to read the QR code but cannot extract any valid information contained or encrypted within the QR code.

The method of the present invention may further include scanning the QR code by a scanning device and extracting from the QR code the link related to the electronic document in the database, and retrieving the electronic document from the database. The method may continue with displaying a content of the retrieved electronic document on the scanning device. QR codes may be scanned by any compatible scanning devices. The scanning device may be a barcode scanner, a mobile device (e.g., smartphone, mobile phone, tablet), a camera, or a camcorder. QR codes may be read and decoded by the scanning devices directly or may be transferred to another device for decoding. A number of QR code decoders are available online or as apps in smartphones.

The present method may include validating integrity of the QR code. It is of importance to ensure that the barcodes function properly and to prevent malfunctioning barcodes by recognizing and diagnosing the problem areas, before they become an issue further down the supply channel. It ensures that the optical characteristics of the barcode can be read by a scanner in the first place. The validation step also checks that the data encoded in the barcode is the data that is intended. The correct data is essential for that code to convey the needed information all the way down the production process.

The electronic document retrieved by the present method may be in a predetermined language. The predetermined language can be a default language set in the scanning device. The electronic document related to the product may be translated into multiple languages and stored in the database. Translation of the electronic document may be carried out automatically or on-demand. Upon receipt of a request of the electronic document, the server hosting the database automatically determines the default language of the requesting device and returns the electronic document in the default language. In the event that the electronic document in the default language of the requesting device is not available, the server may initiate an on-demand translation process to generate the electronic document in the language required.

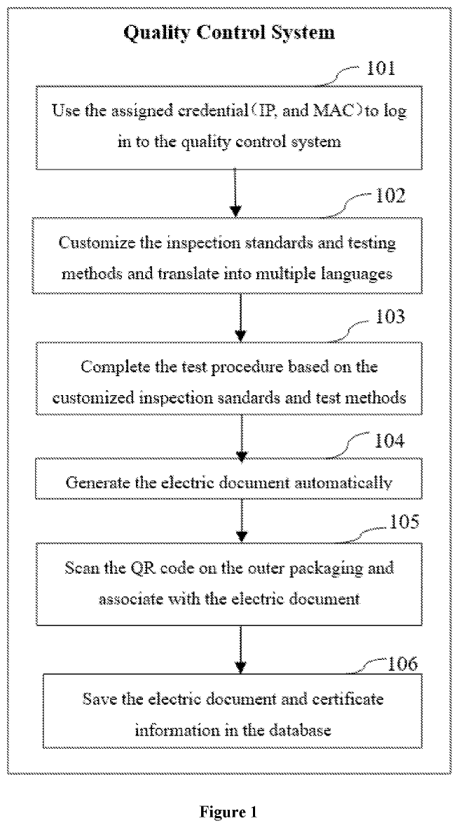

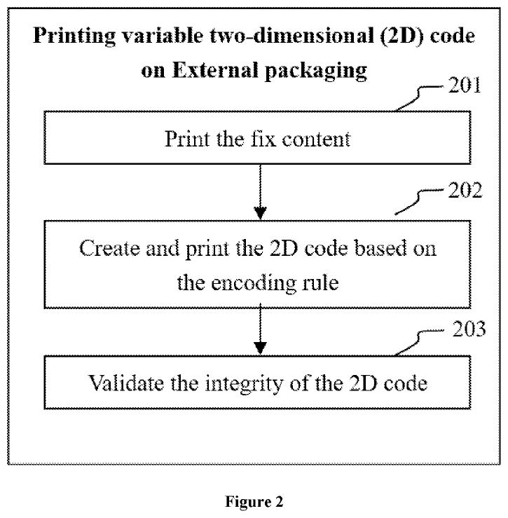

Referring now to FIG. 1, it depicts an embodiment of the method of the present invention for automatically generating and storing multi-language electronic documents by the quality control system. In step 101, an authorized user may login to the quality control system using the assigned credentials (e.g., IP, MAC). The user may customize the inspection standards and test methods specific to the product and/or the product type in step 102. The inspection standards and test methods may be automatically translated into multiple languages. Based on the inspection standards and the test methods set in step 102, the product is tested and inspected in step 103. According to the inspection result in step 103, the relevant multi-language electronic documents are automatically generated in step 104. A packaging supplier or an authorized user may login to the cloud server to obtain the variable data signature rule and print a QR code associated with the electronic document using the variable data printing technique. The QR code may include a Universal Resource Locator (URL) to locate the electronic document and a digital signature. In step 105, the QR code on the outer packaging (e.g., primary packaging, secondary packaging) is scanned and associated with the electronic document to create a connection between the electronic document and the QR code. The electronic document containing product-related information is stored in the database. FIG. 2 is a block diagram of the method for printing a variable QR code on the outer packaging. The fixed content is printed by a packaging supplier in step 201. After the fixed content printing is completed, the variable data printing tool is used to print a unique QR code based on the encoding rule provided by the factory in step 202. Step 203 verifies the integrity of the printed QR code on the outer packaging.

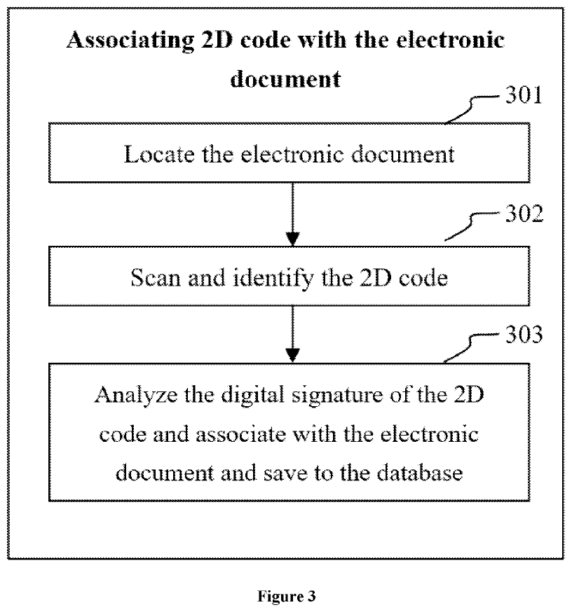

FIG. 3 shows the method of creating the association between the QR code and the electric document. Step 301 locates the electronic document generated in the quality control system. Step 302 locates the QR code printed on the outer packaging. After its digital signature is analyzed in step 303, the QR code is associated with the electronic document and saved into the database.

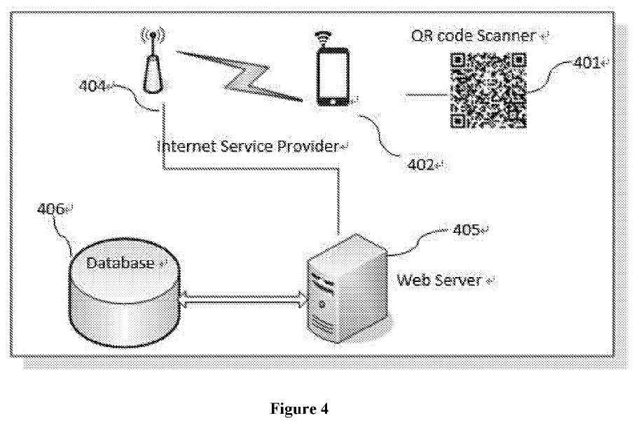

FIG. 4 shows the method and schematic diagram for retrieving the electric document though a QR code. The QR code scanning application software is installed on the network-supported mobile device 402. When 402 scans a QR code, it obtains the cloud server address and product signature information for the product-related electronic document. The mobile device 402 issues a request to the cloud server 405 over the network. The cloud server 405 retrieves the required information from the database 406. In this way, the remote users can use the mobile device to scan the QR code to query and track the multi-language electronic document, and access different levels of information based on their privilege.

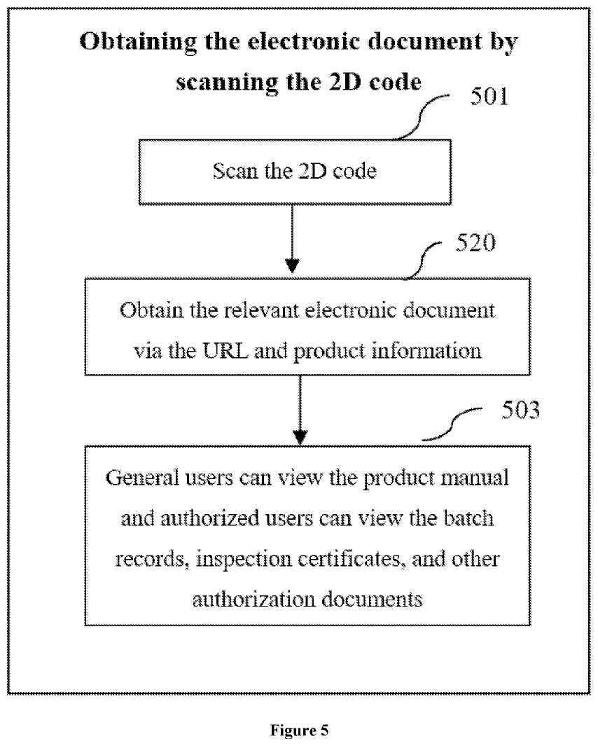

FIG. 5 shows the method for retrieving electric file by a QR code. In step 501, a network-supported terminal device scans the QR code. Step 502 obtains the cloud server address and the product signature information for the product-related multi-language electronic documents based on decoding rule. Step 503 accesses the cloud server through the information obtained by step 502 and display the different levels of information on the terminal screen based on the user's privilege.

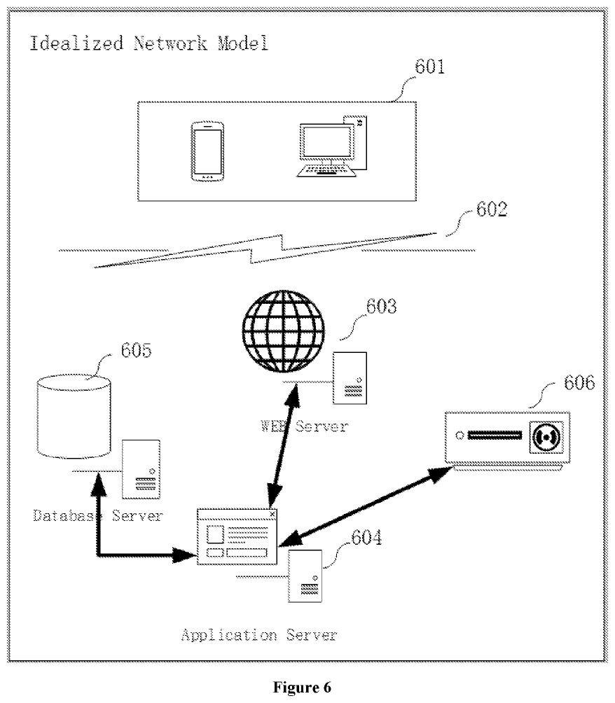

FIG. 6 shows the schematic diagram of an ideal network structure of the quality control system. An end user 601 accesses the remote Web server 603 through the network 602 to the quality control system. The Web server 603 accesses the database through the application server cluster 604 and the database server 605.

In one particular embodiment, the method of the present invention may comprise the stages of: (1) accessing the quality system by the authorized user; (2) customizing the inspection standards and the test methods based on the product and/or the product type (e.g., raw and auxiliary materials, packaging materials, intermediates, finished products); (3) completing the product inspection process according to the inspection standards and testing methods in stage (2); (4) automatically translating and generating the relevant multi-language electronic document after stage (3) is completed; (5) accessing the cloud server and downloading the default encoding rule by system-verified product packaging suppliers and authorized users, and printing different QR code labels for each product using the variable data printing technology; (6) creating the association between the electronic document in stage (4) and the QR code label on the outer packaging of each product created in stage (5); (7) using the mobile device with a scanning function to scan the QR code label on the product created in the stage (5) and the QR code label on the outer packaging; (8) decoding the QR code in stage (7) to obtain the corresponding URL and parameter information; and (9) according to the URL and parameters obtained in stage (8) to access the cloud server and retrieving the different levels of information for the product based on the various user privileges, and displaying it in a predetermined language by detecting the default language of the mobile device.

One of skill in the art will readily appreciate that the foregoing is not necessarily limiting to the invention and that additional embodiments and advantages of the present invention are readily available based on the disclosure provided herein.

What is claimed is:

1. A method of generating and accessing product-related information, the method comprising:
generating an electronic document related to a product; and
associating the electronic document related to the product with a two-dimensional (2D) barcode, wherein the electronic document is accessed by decoding the 2D barcode.

2. The method of claim 1, wherein the 2D barcode is a Quick Response (QR) code.

3. The method of claim 1, wherein generating the electronic document comprises selecting a test method based on a product type and an inspection standard associated with the product.

4. The method of claim 1, wherein generating the electronic document comprises conducting a product inspection process according to the test method and the inspection standard.

5. The method of claim 1, wherein the electronic document is a batch production record, a batch inspection record, or an analysis certificate of the product.

6. The method of claim 1, wherein the electronic document is a multi-language document.

7. The method of claim 1, wherein the electronic document is stored in a database.

8. The method of claim 2, wherein associating the electronic document with the QR code further comprises validating integrity of the QR code.

9. The method of claim 2, wherein the QR barcode comprises a digital signature related to the electronic document, the digital signature being used to authenticate a user and to determine a level of product information the user is authorized to access.

10. The method of claim 2, wherein the QR barcode comprises a link to access the electronic document in the database.

11. The method of claim 2, further comprising:
scanning the QR code by a scanning device;
extracting from the QR code the link related to the electronic document in the database; and
retrieving the electronic document from the database.

12. The method of claim 11, further comprising displaying a content of the retrieved electronic document on the scanning device.

13. The method of claim 11, wherein the scanning device is a mobile device.

14. The method of claim 13, wherein the mobile device is a mobile phone or a tablet.

15. The method of claim 11, wherein the extracted link is a Universal Resource Locator (URL) address for accessing the electronic document on a Web server.

16. The method of claim 11, wherein the retrieved electronic document is in a predetermined language.

17. The method of claim 16, wherein the predetermined language is based on a default language of the scanning device.
